(19) United States
(12) Patent Application Publication
(10) Pub. No.: US 2024/0146823 A1
(43) Pub. Date: May 2, 2024

(54) METHOD FOR SPLITTING SCREEN ON MOBILE COMPUTING APPARATUS AND SYSTEM THEREOF

(71) Applicant: Samsung SDS Co., Ltd., Seoul (KR)

(72) Inventors: Mi Geon CHO, Seoul (KR); In Pyo Kim, Seoul (KR); Yoo Jung Kim, Seoul (KR); Da Gun Lee, Seoul (KR)

(73) Assignee: Samsung SDS Co., Ltd., Seoul (KR)

(21) Appl. No.: 18/384,182

(22) Filed: Oct. 26, 2023

(30) Foreign Application Priority Data
Oct. 31, 2022 (KR) 10-2022-0142180

(51) Int. Cl. H04L 67/564; G06F 3/04842; H04L 67/50

(52) U.S. Cl. CPC H04L 67/564; G06F 3/04842; H04L 67/535; G06F 2203/04803

(57) ABSTRACT

A method, which is performed by at least one processor, includes: displaying a currently running application list in response to a first user input; generating a recommended application set including one or more recommended applications for configuring a split screen for a first application included in the currently running application list; displaying the recommended application set for the first application at a position adjacent to the first application; selecting, based on a second user input, a recommended application in the recommended application set for the first application; configuring a split screen including the first application and the selected recommended application; and automatically displaying the split screen.

### CROSS REFERENCE TO RELATED APPLICATION(S)

This application is based on and claims priority under 35 U.S.C. § 119 to Korean Patent Application No. 10-2022-0142180, filed on Oct. 31, 2022, in the Korean Intellectual Property Office, the disclosure of which is incorporated by reference herein in its entirety.

### BACKGROUND

### 1. Field

The disclosure relates to a method for configuring a split screen of a mobile computing apparatus and a system, to which the method is applied. More particularly, the disclosure relates to a method of recommending applications constituting a split screen based on application usage information of a user and automatically determining a disposition region of each application in the split screen.

### 2. Description of the Related Art

In a mobile computing apparatus, a split screen configuration function is actively used in order for a user to use a plurality of applications simultaneously. The situation in which the user configures the split screen often requires a combination of applications activated by the user or frequently used applications.

However, referring to FIG. 1, in a case of the conventional split screen configuration method, there is a problem that the user's process of configuring the split screen is cumbersome, since it is necessary to go through an operation of checking a list of applications activated by a user, an operation of a user searching for an application constituting a split screen in the entire application list, an operation of the user determining to run the application as a split screen, and an operation of the user directly adjusting the screen layout ratio of each application constituting the split screen.

Therefore, it is required to provide a function, in which a user can conveniently and quickly start a split screen with a desired combination of applications, and the ratio of area occupied by each application in the screen according to the properties of each application and the screen division direction are automatically set. However, the conventional method of configuring a split screen in a mobile computing apparatus fails to provide such a function and makes it difficult to match the properties of each application with the logic constituting the split screen, making it difficult to implement such a function.

### SUMMARY

Provided are a method of generating a set of recommended applications for configuring a split screen within a reference distance of a list of currently running applications.

Provided are a method of providing a recommended application set for configuring a split screen based on history information of a user manipulating each application, properties of each application, and history information of configuring a split screen between applications.

Provided are a method for a user to conveniently execute a plurality of applications in a split screen through a drag and drop manipulation.

Provided are a method for determining a display direction of a split screen based on a type of content provided by each application constituting the split screen.

Provided are a method for determining a region where an interface of each application constituting the split screen is disposed based on the number of applications constituting the split screen, the application usage frequency of each application constituting the split screen, the user manipulation frequency during execution, and a type of content provided by each application constituting the split screen.

Provided are a method for determining a size of a region where an interface of each application constituting the split screen is disposed based on the number of applications constituting the split screen, the user manipulation frequency during execution of each application constituting the split screen, and a type of content provided by each application constituting the split screen.

The technical problems of the present disclosure are not limited to the above-mentioned technical problems, and other technical problems not mentioned will be clearly understood by those skilled in the art from the following description.

According to an aspect of the disclosure, a method performed by at least one processor, the method includes: displaying a currently running application list in response to a first user input; generating a recommended application set including one or more recommended applications for configuring a split screen for a first application included in the currently running application list; displaying the recommended application set for the first application at a position adjacent to the first application; selecting, based on a second user input, a recommended application in the recommended application set for the first application; configuring a split screen including the first application and the selected recommended application; and automatically displaying the split screen.

In some embodiments, the automatically displaying of the split screen includes automatically displaying the split screen without additional user input after the second user input.

In some embodiments, an application included in the recommended application set is determined based on at least one of: history information of configuring a split screen with the first application, history information of a user alternately using the first application and other applications in the currently running application list, time information, at which a user executed the first application and the other applications in the currently running application list, or developer information of each of the first application and the other applications.

In some embodiments, the second user input includes: a manipulation of dragging an application execution button in the recommended application set and releasing the application execution button in a first region of a screen; and a manipulation of dragging a reduced interface of a second application included in the currently running application list and releasing the reduced interface of the second application within m pixels of a boundary of a reduced interface of the first application.

In some embodiments, the generating of the recommended application set includes, assigning a recommendation score to each of applications in the recommended application set; and determining that a predefined number of applications among the applications in the recommended application set is to be included in the recommended application set, wherein the recommendation score is calculated by assigning different weights to: history information of configuring a split screen with the first application, history information of a user alternately using the first application and other applications, time information, at which a user executed the first application and the other applications, and developer information of the first application and the other applications.

In some embodiments, the generating of the recommended application set further includes: based on a determination that a plurality of applications having a same recommendation score exist, generating the recommended application set including an application having a larger execution number in the recommended application set.

According to an aspect of the disclosure, a method performed by at least one processor, the method includes: identifying a plurality of applications constituting a split screen, wherein the plurality of applications include a first application and a second application;
automatically determining a layout of the split screen by using a property of the first application and a property of the second application; and displaying the split screen having the automatically determined layout.

In some embodiments, the automatically determining of the layout of the split screen includes: determining a first rule for determining a display direction of the split screen based on a type of content provided by each of the first application and the second application; determining a second rule for determining a region, in which an interface of each of the first application and the second application is disposed, based on the determined first rule, wherein the second rule is determined based on a number of applications constituting the split screen, a user manipulation frequency during execution of each of the first application and the second application and a type of content provided by each of the first application and the second application; and determining a third rule for determining a size of a region, in which the interface of each of the first application and the second application is disposed, based on the number of applications constituting the split screen, the user manipulation frequency during execution of each of the first application and the second application, and the type of content provided by each of the first application and the second application.

In some embodiments, the determining of the first rule includes: based on a determination that at least one of the first application or the second application provides video content, determining the first rule.

In some embodiments, the determining of the first rule further includes: based on a determination that an average running time of video content-providing applications is equal to or less than a predefined time, determining that the first rule is a second direction regardless of whether the first application and the second application provide the video content.

In some embodiments, the determining of the first rule further includes: based on a determination that at least one of the first application or the second application is a pre-designated application, determining that the first rule is a second direction regardless of whether the at least one of the first application or the second application provides the video content.

In some embodiments, the determining of the second rule includes: based on a determination that the first rule is a first direction, determining that an interface of the first application having a higher user manipulation frequency than the second application during an execution of the first application and the second application is disposed in a lower portion of an interface of the second application.

In some embodiments, the determining of the second rule further includes: based on a determination that user manipulation frequencies are similar to each other and equal to or greater than a reference value during an execution of each of the first application and the second application, determining the second rule based on an execution frequency of each of the first application and the second application.

In some embodiments, the determining of the second rule further includes, based on a determination that the first rule is a second direction: determining a main interaction direction of a user based on position information of a region on a screen touched by the user; and determining that an interface of the first application having a higher user manipulation frequency than the second application during an execution of the first application and the second application is disposed in the main interaction direction of the user.

In some embodiments, the determining of the third rule includes: determining that an interface of the first application having a higher user manipulation frequency than the second application during an execution of the first application and the second application is to be displayed on two-thirds (⅔) or more of a screen; and based on a determination that user manipulation frequencies of the first application and the second application are similar to each other and equal to or greater than a first reference value during an execution of each of the first application and the second application, determining that an interface of the first application having a higher execution frequency than the second application among the first application and the second application is to be displayed on two-thirds (⅔) or more of the screen.

In some embodiments, the determining of the third rule further includes: based on a determination that execution frequencies of each of the first application and the second application are similar to each other and equal to or greater than a second reference value, determining a size of a region where each of the first application and the second application is disposed to be same.

In some embodiments, the determining of the third rule includes: based on a determination that the first application providing video content exists among the first application and the second application and that the first rule is a first direction, determining a size of a region where the second application is disposed within the split screen based on a horizontal resolution of the video content of the first application; and based on a determination that the first application providing video content exists among the first application and the second application and that the first rule is a second direction, determining the size of the region where the second application is disposed within the split screen based on a vertical resolution of the video content of the first application.

In some embodiments, the method further includes: based on a determination that: there is a first history of the first application and the second application configuring a split screen together in the past, and there is a second history of a user adjusting at least one of the first rule, the second rule, or the third rule to configure the split screen by using the first application and the second application, configuring a split screen by applying the at least one of the first rule, the second rule, or the third rule adjusted by the user in the past.

According to an aspect of the disclosure, a computing apparatus includes: one or more processors; and a memory configured to store one or more instructions, wherein the one or more processors, by executing the stored one or more instructions, perform: displaying a currently running application list in response to a first user input; generating a recommended application set including one or more recommended applications for configuring a split screen for a first application included in the currently running application list; displaying the recommended application set of the first application at a position adjacent to the first application; based on a second user input, selecting a recommended application in the recommended application set for the first application; configuring a split screen including the first application and the selected recommended application; and automatically displaying the split screen.

According to an aspect of the disclosure, a computing apparatus includes: one or more processors; and a memory configured to store one or more instructions, wherein the one or more processors, by executing the stored one or more instructions, perform: identifying a plurality of applications constituting a split screen, wherein the plurality of applications include a first application and a second application; automatically determining a layout of the split screen by using a property of the first application and a property of the second application; and displaying the automatically determined split screen having the determined layout.

Aspects of the present disclosure for solving the problems provide a system for splitting screen on mobile computing apparatus. The system may comprise one or more processors and a memory for storing one or more instructions. The one or more processors, by executing the stored one or more instructions, may perform operations comprising, identifying a plurality of applications constituting a split screen, wherein the plurality of applications comprise a first application and a second application, automatically determining a layout of the split screen using a property of the first application and a property of the second application and displaying the automatically determined split screen.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram for illustratively describing a conventional split screen configuration method;

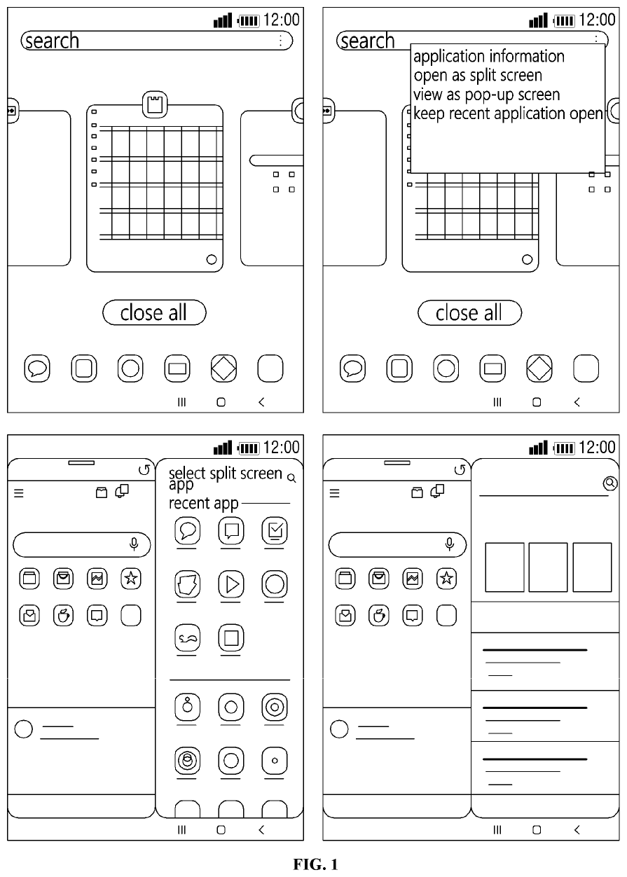

FIG. 2 is a flowchart of a method for configuring a split screen of a mobile computing apparatus according to an embodiment of the disclosure;

FIG. 3 is an example diagram for describing a user interface that may be displayed as a result of performing some embodiments of the disclosure;

FIG. 4 is an example diagram for describing a user interface that may be displayed as a result of performing some embodiments of the disclosure;

FIG. 5 is an example diagram for describing a set of additionally provided recommended applications that may be displayed as a result of performing some embodiments of the disclosure;

FIG. 6 is a flowchart for describing some operations described with reference to FIG. 2 in more detail;

FIG. 7 is an example diagram for describing a second user input mentioned in some embodiments of the disclosure;

FIG. 8 is an example diagram for describing a second user input referred to in some embodiments of the disclosure;

FIG. 9 is an example diagram for describing a second user input referred to in some embodiments of the disclosure;

FIG. 10 is a flowchart of a method for configuring a split screen of a mobile computing apparatus according to another embodiment of the disclosure;

FIG. 11 is a diagram for describing in detail some of the operations described with reference to FIG. 10;

FIG. 12 is a flowchart of a method of determining a region where each application is disposed when a split screen arrangement direction is a horizontal direction and there are two applications constituting the split screen according to some embodiments of the disclosure;

FIG. 13 is a flowchart of a method of determining a region where each application is disposed when a split screen arrangement direction is a horizontal direction and there are three applications constituting the split screen according to some embodiments of the disclosure;

FIG. 14 is a flowchart of a method of determining a region where each application is disposed when a split screen arrangement direction is a horizontal direction and there are three applications constituting the split screen according to some embodiments of the disclosure;

FIG. 15 is a diagram illustrating a split screen that may be displayed as a result of performing some embodiments of the disclosure;

FIG. 16 is a flowchart of a method of determining a region where each application is disposed when a split screen arrangement direction is a vertical direction and there are two applications constituting the split screen according to some embodiments of the disclosure;

FIG. 17 is a flowchart of a method of determining a region where each application is disposed when a split screen arrangement direction is a vertical direction and there are three applications constituting the split screen according to some embodiments of the disclosure;

FIG. 18 is a diagram illustrating a split screen that may be displayed as a result of performing some embodiments of the disclosure;

FIG. 19 is a flowchart of an operation of determining the size of a region where an interface of each split screen application is disposed according to some embodiments of the disclosure;

FIG. 20 is a diagram for describing in detail some operations described with reference to FIG. 19; and

FIG. 21 is a hardware configuration diagram of a computing apparatus according to another embodiment of the disclosure.

### DETAILED DESCRIPTION

Hereinafter, example embodiments of the disclosure will be described with reference to the attached drawings. Advantages and features of the disclosure and methods of accomplishing the same may be understood more readily by reference to the following detailed description of example embodiments and the accompanying drawings. The disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the disclosure will be defined by the appended claims and their equivalents.

In adding reference numerals to the components of each drawing, the same reference numerals are assigned to the same components as much as possible even though they are shown in different drawings. In addition, in describing the disclosure, when it is determined that the detailed description of the related well-known configuration or function may obscure the gist of the disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Prior to description of various embodiments of the disclosure, terms used in the following embodiments will be clarified.

An ‘application’ of the disclosure may be a collective term for software that is executed in an operating system installed in a mobile computing apparatus. In the art, the application may be used interchangeably with terms such as ‘app’ or ‘application program.’

The ‘split screen’ of the disclosure may refer to an application execution mode, in which interfaces of a plurality of applications are simultaneously executed by dividing the display included in the mobile computing apparatus into a specific size. In the art, the split screen may be used interchangeably with terms such as ‘multi window’ and ‘multitasking.’

The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. Similarly, the term “set” means one or more. Accordingly, the set of items may be a single item or a collection of two or more items.

Hereinafter, several embodiments of the disclosure are described with reference to the drawings.

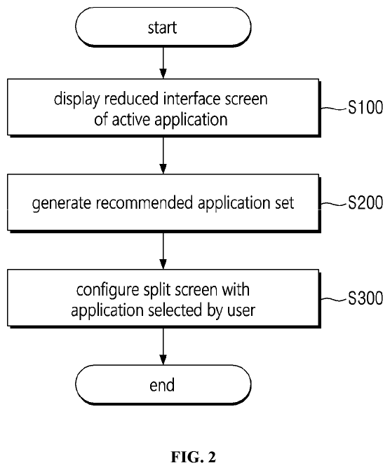

FIG. 2 is a flowchart of a method for configuring a split screen of a mobile computing apparatus according to an embodiment of the disclosure. The operations described below in some flowcharts are performed by a computing apparatus unless otherwise specified. In some embodiments of the disclosure, the computing apparatus may be understood as a mobile computing apparatus including a touch screen.

In operation S100, the computing apparatus may display a list of active applications in response to the first user input. The list of active applications may be displayed in a reduced interface screen of the active applications.

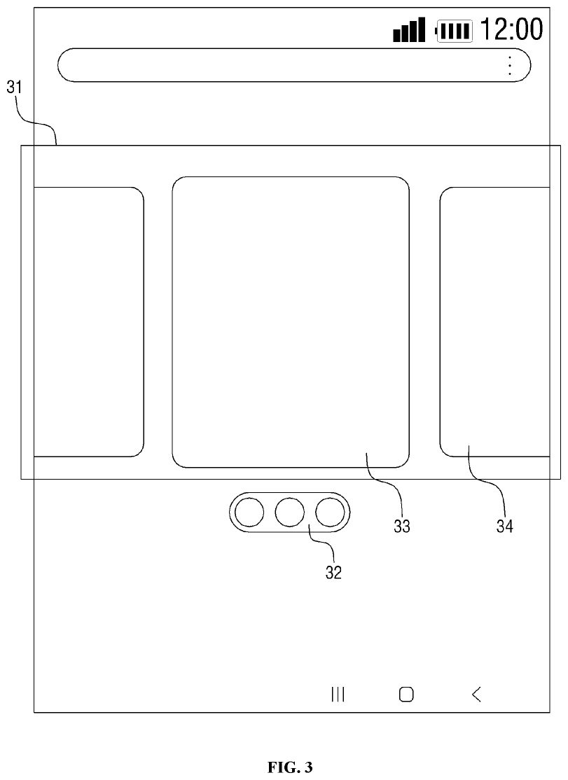

In some embodiments related to operation S100, referring to FIG. 3, the first user input may mean an input where the user touches a manipulation means to the predefined lower portion region of the display of the computing apparatus, and moves the manipulation means to the upper portion equal to or greater than a predefined distance and then releases it. Also, the computing apparatus may display the active application list 31 in response to the first user input.

In some other embodiments related to operation S100, the first user input may be a user manipulating a specific button of the computing apparatus. Also, the computing apparatus may display the active application list 31 in response to the first user input.

In some other embodiments related to operation S100, the first application 33 may be an application that the user was using right before the first user input.

In operation S200, the computing apparatus may generate a set of recommended applications in response to a first user input. Here, the first user input may be understood as the same as the first user input mentioned in operation S100. That is, referring to FIG. 3, the computing apparatus may display a list of active applications 13 in response to the first user input, and generate and display a recommended application set 32.

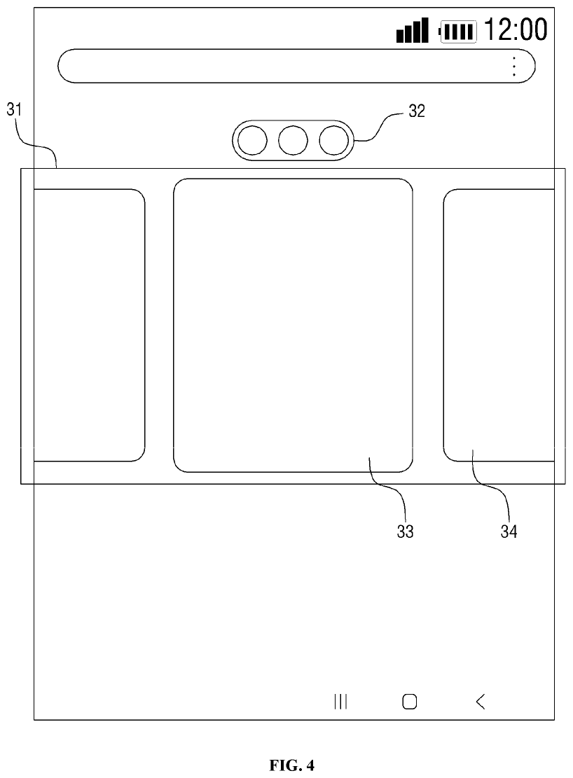

In some embodiments related to operation S200, referring to FIG. 4, the recommended application set 32 may be displayed in the upper portion of the active application list 31.

Also, the recommended application set may be a set of applications recommended by the computing apparatus to configure a split screen with the first application.

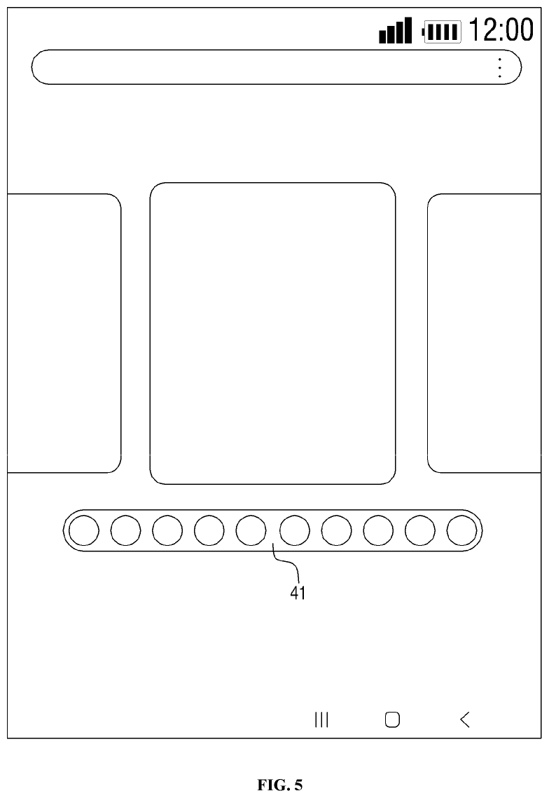

In some embodiments related to operation S200, as shown in FIG. 5, when referring to the recommended application set 41, in which some applications are provided additionally, the number of applications included in the recommended application set 41 can increase or decrease based on the user's setting.

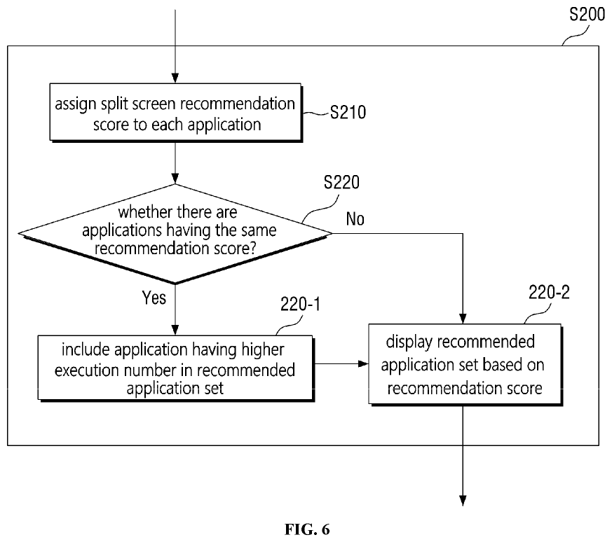

Hereinafter, in order to describe operation S200 in more detail, it will be described with reference to FIGS. 6 to 9.

In operation S210 shown in FIG. 6, the computing apparatus may assign a recommendation score to each application stored or installed in the computing apparatus. Here, the recommendation score may be a reference value by which the computing apparatus determines whether to include each of the applications in the recommended application set.

In some embodiments related to operation S210, the computing apparatus may assign a recommendation score of each application based on history information on whether each of the applications has configured a split screen together with the first application in the past, history information of a user alternately using each of the applications and the first application, time information when the user executed each of the applications, and developer information of each of the applications. Here, the first application may be an application determined as constituting the split screen the user was using prior to the first user input.

In addition, the history information of the user alternately using each of the applications and the first application is that, for example, referring to FIG. 3, while using the first application 33, if the user initiates the second application 34 from the list of active applications 31 through the first user input by manipulating the reduced interface screen of the second application 34, and if the user initiates the first application 33 again within a reference time, the history of alternating use between the second application 34 and the first application 33 can be incremented by one instance.

In some other embodiments related to operation S210, the computing apparatus may calculate a history that each of the applications is executed at the same time as the first application, based on information on the execution time of each of the applications.

For example, if the first application is executed at 18:49 and the second application is executed at 19:30, which is within one hour from 18:49, the history that the second application is executed in the same time zone as the first application can be incremented by one instance.

In still some other embodiments related to operation S210, the computing apparatus may calculate a recommendation score of each of the applications by assigning different weights to history information on whether each of the applications has configured a split screen together with the first application in the past, history information of a user alternately using each of the applications and the first application, time information when the user executed each of the applications, and developer information of each of the applications.

For example, the computing apparatus may assign a weight of 4 to history information on whether each of the applications has configured a split screen with the first application in the past, assign a weight of 3 to the history information that the user alternately used each of the applications and the first application, assign a weight of 2 to time information when the user executed each of the applications, and assign a weight of 1 to developer information of each of the applications.

According to the above example, if application A has configured a split screen with the first application 2 times in the past, the user alternately used application A and the first application 3 times, application A was executed 2 times at the same time as the first application, and the application A is not developed by the same developer as the first application, the recommendation score of the application A may be (4*2)+(3*3)+(2*2)+(1*0)=21 points.

In this case, application A may have a higher probability of being included in the recommended application set than application B having a recommendation score of 20 points.

Next, in operation S220, the computing apparatus may evaluate whether there are applications having the same recommendation score.

In operation S220-1, if there are applications having the same recommendation score, the computing apparatus may include an application having a greater execution number in the recommended application set.

In some embodiments related to operation S220-1, for example, when the user sets four applications to be included in the recommended application set generated by the computing apparatus, and applications A to E with higher recommendation scores exist, where the recommendation scores of application D and application E are the same, the computing apparatus may determine application D as the last component of the recommended application set in response to determining that the number of executions of application D is one more.

In operation S220-2, the computing apparatus may display a recommended application set based on the recommendation score. Here, in the displayed recommended application set, for example, when the user sets the recommended application set to include 10 applications, the computing apparatus may display a recommended application set 41 including 10 applications, such as the additionally provided recommended application set 41 shown in FIG. 5.

Hereinafter, the description continues with reference to FIG. 2.

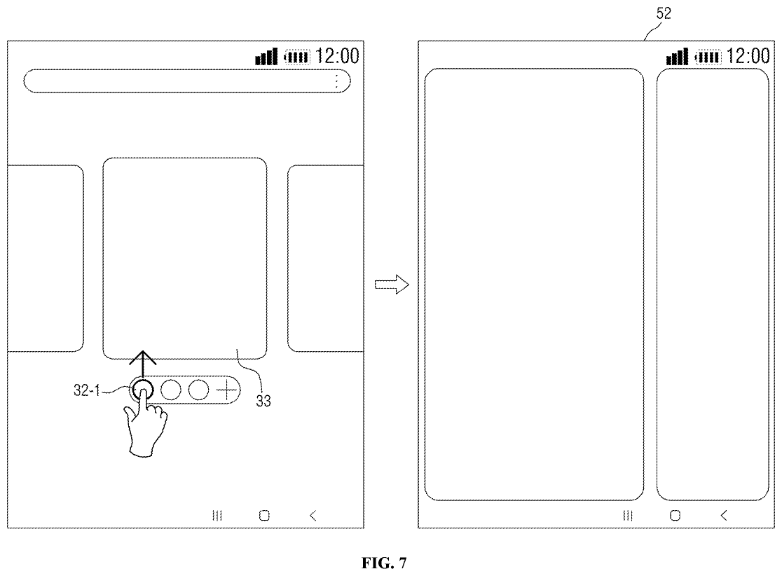

In operation S300, the computing apparatus may configure a split screen with a plurality of applications selected by the user. In order to describe the operation of configuring the split screen in more detail, it will be described with reference to FIGS. 7 to 9.

In some embodiments related to operation S300, referring to FIG. 7, the computing apparatus may display the split screen 52 comprising the interface screen of the application corresponding to the first application 33 and the application icon 32-1 in the recommended application set in response to an operation, in which a user drags an application icon 32-1 in the recommended application set and releases it in the first region of the screen of the computing apparatus.

Here, the first region may be a predefined region within the reduced interface screen of the first application 33.

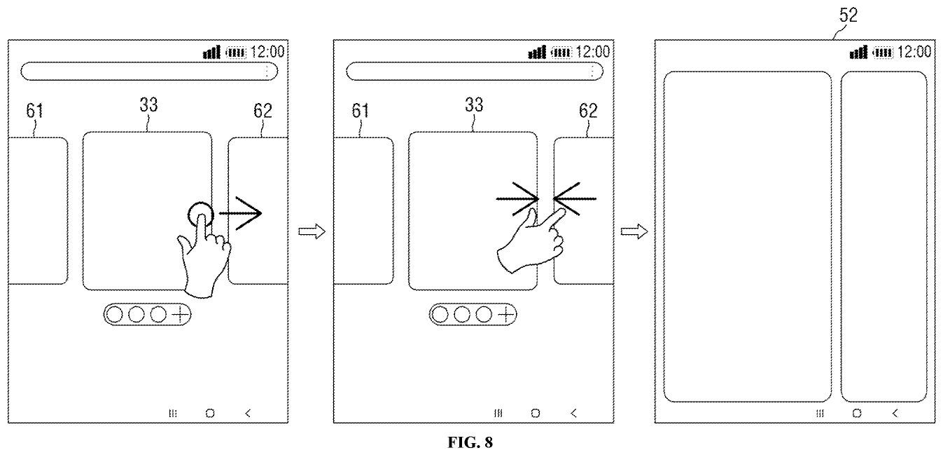

In some other embodiments related to operation S300, referring to FIG. 8, the computing apparatus may display the split screen 52 comprising the interface screens of the first application 33 and the second application 62 in response to an operation, in which the user drags a reduced interface of the first application 33 and a reduced interface of the second application 62 at the same time and releases the reduced interface of the first application 33 and the reduced interface of the second application 62 in a state, in which a region of a predetermined size or more overlaps.

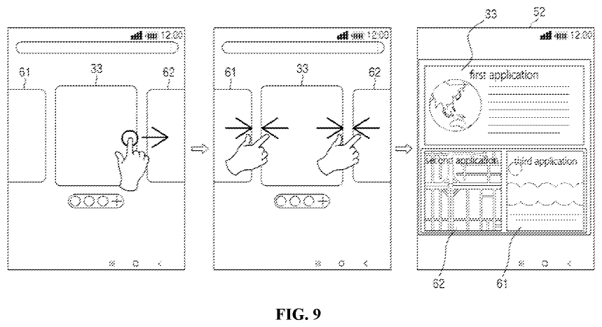

In some other embodiments related to operation S300, referring to FIG. 9, the computing apparatus may display the split screen 52 comprising interface screens of the first application 33, the second application 62, and the third application 61 in response to an operation, in which the user drags a reduced interface of the first application 33, a reduced interface of the second application 62, and a reduced interface a third application 61 at the same time and releases the reduced interface of the first application 33, the reduced interface of the second application 62, and the reduced interface of the third application 61 in a state, in which a region of a predetermined size or more overlaps.

So far, a method for configuring a split screen of a mobile computing apparatus according to an embodiment of the disclosure has been described in detail with reference to FIGS. 2 to 9. The embodiments described above are illustrative in all respects and not restrictive.

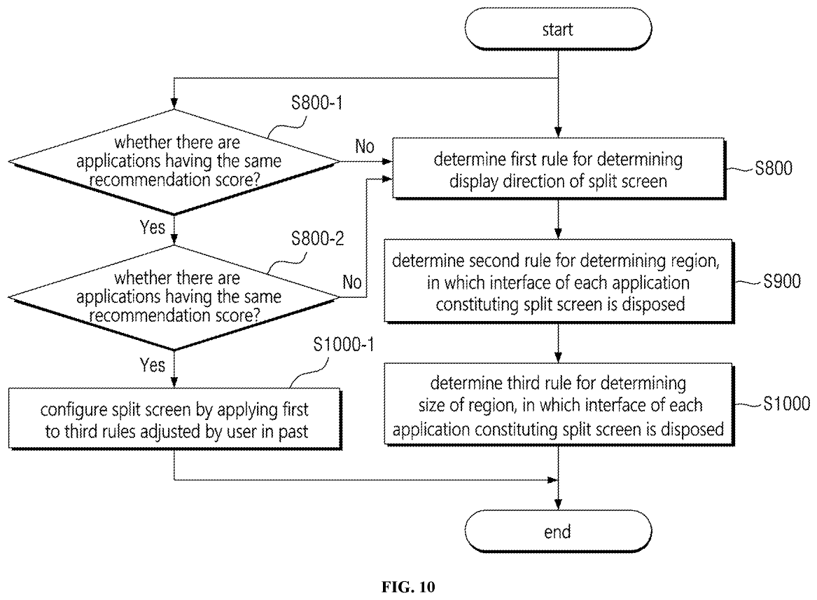

Hereinafter, a method for configuring a split screen of a mobile computing apparatus according to another embodiment of the disclosure will be described in detail with reference to FIGS. 10 to 20. A subject of operations to be described in some flowcharts may be understood to be the computing apparatus unless otherwise specified.

FIG. 10 is a flowchart of a method for configuring a split screen of a mobile computing apparatus according to another embodiment of the disclosure.

In operation S800-1, the computing apparatus may evaluate whether there is a history that the applications constituting the split screen configured a split screen together. For example, assuming that a user selects application A and application B as applications constituting a split screen, the computing apparatus may evaluate whether there is a history that applications A and B configured a split screen in the past.

In some embodiments related to operation S800-1, the computing apparatus may perform operation S800 in response to determining that there is no history that the applications constituting the split screen configured a split screen together.

In some other embodiments related to operation S800-1, the computing apparatus may perform operation S800-2 in response to determining that there is a history that the applications constituting the split screen configured a split screen together.

In operation S800-2, the computing apparatus may evaluate, when the applications constituting the split screen configured a split screen together in the past, whether there is a history of adjusting at least one of the first to third rules for the corresponding split screen. The first to third rules will be described in detail later.

In some embodiments related to operation S800-2, in response to determining that there is a history of adjusting at least one of the first to third rules for the corresponding split screen when the applications constituting the split screen configured the split screen together in the past, the computing apparatus may perform operation S1100-1.

For example, when a split screen comprising application A and application B was configured in the past, and the user adjusts the ratio of the interface screen of application A occupying the split screen, the computing apparatus may determine that the user has a history of adjusting the third rule for the split screen when application A and application B configured together a split screen in the past.

In some embodiments related to operation S800-2, in response to determining that there is no history of adjusting at least one of the first to third rules for the split screen when the applications constituting the split screen configured the split screen together in the past, the computing apparatus may perform operation S800.

In operation S1100-1, in response to determining that there is history of adjusting at least one of the first to third rules for the split screen when the applications constituting the split screen configured the split screen together in the past, the computing apparatus may configure the split screen by applying the first to third rules adjusted by the user in the past.

For example, in response to the user's input for configuring a split screen comprising application A and application B, and in response to determining that there is a history of the user adjusting the arrangement direction of the split screen comprising application A and application B when application A and application B configured the split screen together in the past, the computing apparatus may configure the split screen by applying the first to third rules of the split screen comprising application A and application B.

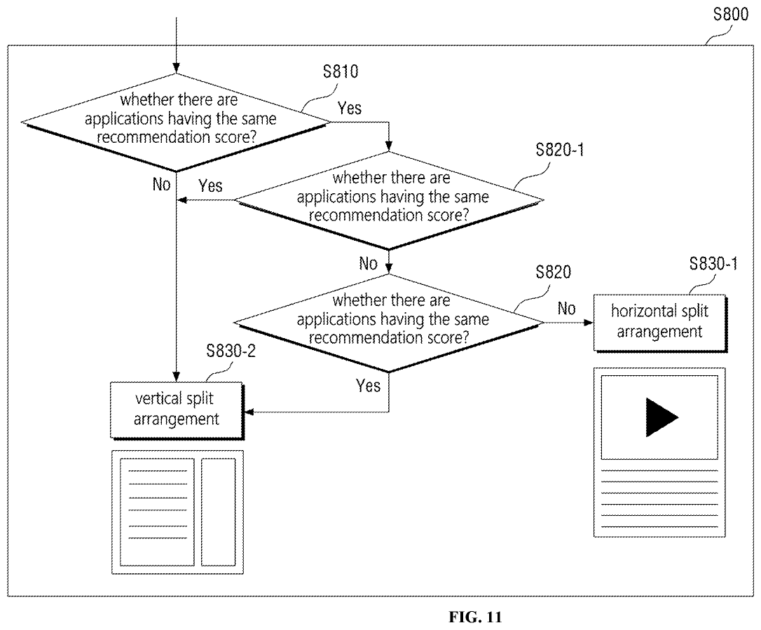

In operation S800, the computing apparatus may determine a first rule for determining the display direction of the split screen. Hereinafter, the operation of determining the first rule will be described with reference to FIG. 11 to describe in more detail.

In operation S810, the computing apparatus may evaluate whether an application providing video content exists among applications constituting the split screen. Here, the computing apparatus may determine whether each of the applications provides video content based on whether video is included in the current interface screen of each of the applications and a running time during which each of the applications reproduced the video during execution.

In operation S820-1, in response to determining that there is an application providing video content among the applications constituting the split screen, the computing apparatus may evaluate whether a pre-specified application is included in the applications constituting the split screen. In addition, in response to determining that a pre-specified application is included in the applications constituting the split screen, the computing apparatus may configure the split screen in a vertical direction, but this will be described later.

In operation S820, in response to determining that the application constituting the split screen does not include a pre-specified application, the computing apparatus may evaluate whether an average running time of video content among applications constituting the split screen is 5 minutes or less.

In some embodiments related to operation S820, the running time may be a time during which the video content is reproduced after the user executes a specific application.

In some other embodiments related to operation S820, the running time may be an average value of the time the user plays video while using a specific application.

In operation S830-1, in response to determining that there is an application providing video content among applications constituting the split screen, a pre-specified application is not included in the applications constituting the split screen, and the average running time of the applications providing video content exceeds 5 minutes, the computing apparatus may determine a first rule for determining the display direction of the split screen as the first direction.

In some embodiments related to operation S830-1, configuring the split screen in the first direction by the computing apparatus may mean splitting and displaying a plurality of application interface screens into the upper and lower portions, as shown in FIG. 11.

In operation S830-2, the computing apparatus may determine the first rule for determining the display direction of the split screen as the second direction.

In some embodiments related to operation S830-2, in response to determining that there is no application providing video content among the applications constituting the split screen, the computing apparatus may determine the first rule for determining the display direction of the split screen as the second direction.

In some other embodiments related to operation S830-2, in response to determining that a pre-specified application is included in the applications constituting the split screen, the computing apparatus may determine the first rule for determining the display direction of the split screen as the second direction.

In some other embodiments related to operation S830-2, in response to determining that the average running time of applications providing video content among applications constituting the split screen is 5 minutes or less, the computing apparatus may determine the first rule for determining the display direction of the split screen as the second direction.

In some other embodiments related to operation S830-2, configuring the split screen in the first direction by the computing apparatus may mean dividing and displaying a plurality of application interface screens into left and right sides, as shown in FIG. 11.

Hereinafter, the description continues with reference to FIG. 10.

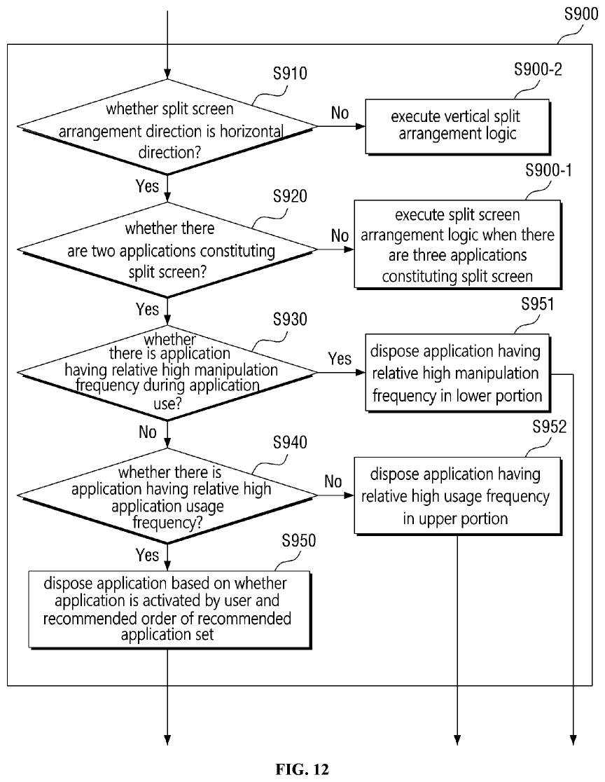

In operation S900, the computing apparatus may determine a second rule for determining a region, in which an interface of each application constituting the split screen is disposed. Hereinafter, to help understanding of some embodiments of the disclosure, a plurality of applications constituting the split screen are defined as a first application and a second application, respectively. In addition, in order to describe the operation of determining the second rule in more detail, it will be described with reference to FIGS. 12 to 15.

In operation S910 shown in FIG. 12, the computing apparatus may evaluate whether the split screen arrangement direction is the horizontal direction.

In some embodiments related to operation S910, the computing apparatus may perform operation S900-2 in response to determining that the split screen arrangement direction is the vertical direction, but operation S900-2 will be described later.

In operation S920, the computing apparatus may evaluate the number of applications constituting the split screen. In some embodiments related to operation S920, the computing apparatus may perform operation S900-1 in response to determining that the number of applications constituting the split screen exceeds two, but the operation S900-1 will be described later.

In operation S930, the computing apparatus may evaluate the frequency of manipulation of each of the first application and the second application by the user while using the application. For example, the operation of evaluating the manipulation frequency may include evaluating a history of the user's interaction with each of the first application and the second application. In addition, in order to help understand some embodiments of the disclosure, the frequency at which the user manipulates the specific application while using the application is defined as ‘application manipulation frequency.’

For another example, while the number of times the user touched the interface of the first application while using the first application was 15000, the number of times the user touched the interface of the second application while using the second application was 16000. In this case, the manipulation frequency during application use is higher for the second application than for the first application.

In operation S951, in response to determining that, among applications constituting the split screen, there is an application having an application manipulation frequency higher than the other application constituting the split screens by a reference value or more, the computing apparatus may dispose an interface of the application having a relatively high application manipulation frequency in the lower portion of the horizontal split screen.

For example, in response to determining that, among the first application and the second application constituting the split screen, the application manipulation frequency of the first application is 1000 times higher than that of the second application, the computing apparatus may determine an application disposed in the lower portion of the horizontal split screen as the first application.

In operation S940, in response to determining that application manipulation frequencies of all applications constituting the split screens are all similar to each other equal to or greater than a reference value, the computing apparatus may evaluate whether an application having a relatively high application usage frequency exists. Here, the application usage frequency may mean the number of times the user executes a specific application.

In operation S952, the computing apparatus may determine that, among applications constituting the split screen, an application having an application usage frequency equal to or greater than a reference value compared to other applications will be disposed in the upper portion of the horizontal split screen.

In operation S950, in response to determining the first rule is the horizontal direction, there are two applications constituting the split screen, the manipulation frequencies of all applications constituting the split screen are similar to each other equal to or greater than the reference value, and the execution frequencies of all application constituting the split screen are similar to each other equal to or greater than the reference value, the computing apparatus may dispose each application on the horizontal split screen based on whether the application is currently activated by the user and the recommendation order of the recommended application set.

In some embodiments related to operation S950, the computing apparatus may determine that the first application, which is the currently activated application, will be disposed in the lower portion of the horizontal split screen, and the second application dragged from the recommended application set will be disposed in the upper portion of the horizontal split screen.

In some embodiments related to operation S950, the computing apparatus may determine that the first application with a recommendation score of 21 points will be disposed in the lower portion of the horizontal split screen, and the second application with a recommendation score of 19 points will be disposed in the upper portion of the horizontal split screen.

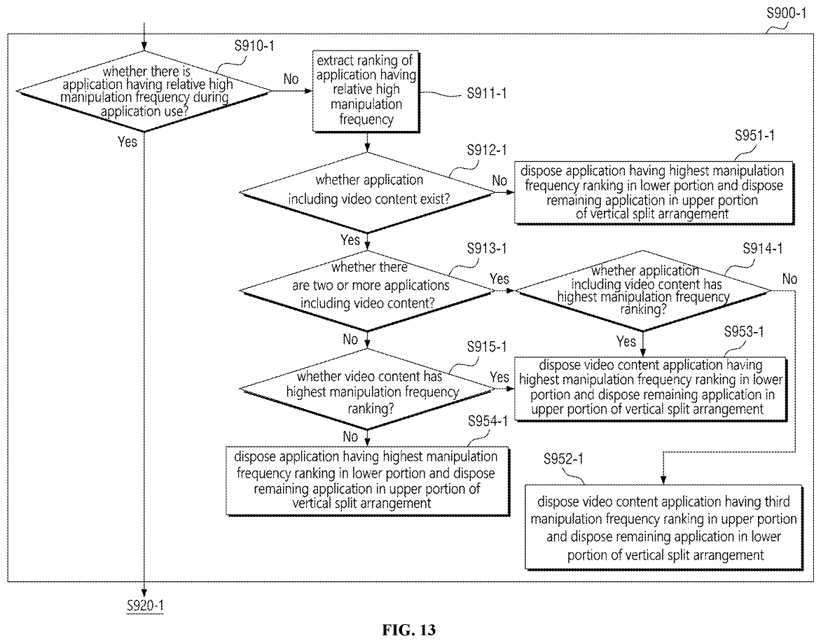

Hereinafter, operation S900-1 shown in FIG. 12 will be described in detail with reference to FIGS. 13 to 15. It can be understood that operation S900-1 is an operation of the computing apparatus determining positions where the applications constituting the split screen will be disposed when there are three applications constituting the split screen and the split screen arrangement direction is determined as the horizontal direction.

Meanwhile, in operations S910-1 and S930 shown in FIG. 13, the computing apparatus may evaluate application manipulation frequencies of the first, second, and third applications, respectively.

In some embodiments related to operation S910-1, the computing apparatus may execute operation S920-1 in response to determining that application manipulation frequencies of the first, second, and third applications are all similar to each other equal to or greater than a reference value. However, operation S920-1 will be described later in detail.

In operation S911-1, the computing apparatus may extract application manipulation frequency rankings of the first to third applications based on the application manipulation frequency.

In operation S912-1, the computing apparatus may evaluate whether an application including video content exists among the first to third applications.

In operation S951-1, in response to determining that an application including video content does not exist among the first to third applications, the computing apparatus may determine that the application having the highest manipulation frequency ranking will be disposed in the upper portion of the horizontal split screen, and the remaining two applications will be disposed in the lower portion of the horizontal split screen, respectively.

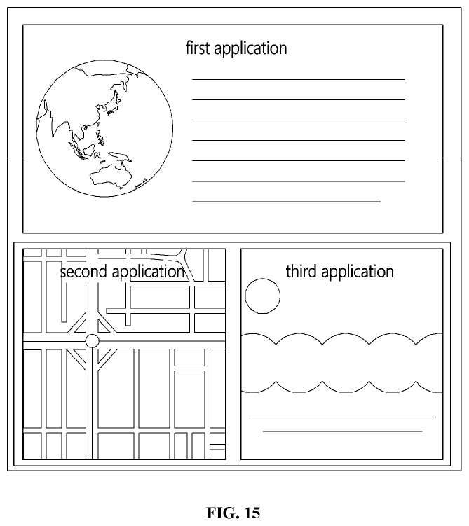

In some embodiments related to operation S951-1, referring to FIG. 15, in response to determining that there is no application including video content among the first to third applications 141, 142, and 143, the computing apparatus may determine that the first application 141 having the highest manipulation frequency ranking will be disposed in the upper portion of the horizontal split screen, and the second application 142 and the third application 143 will be disposed in the lower portion of the horizontal split screen, respectively, as shown in FIG. 15.

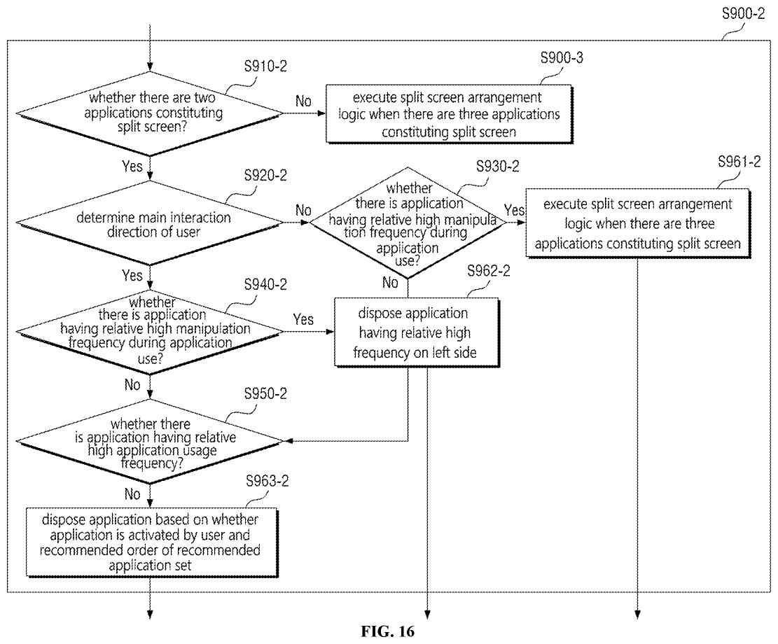

Here, the method for determining the positions of the second application 142 and the third application 143 within the lower portion of the horizontal split screen may be the same as the method of determining the region, in which each application is disposed when the split screen arrangement direction is the vertical direction, as shown in FIG. 16, and there are two applications constituting the split screen.

In operation S913-1, the computing apparatus may evaluate whether there are two or more applications including video content when an application including video content exists among the first to third applications.

In operation S914-1, in response to determining that there are two or more applications including video content among the first to third applications, the computing apparatus may evaluate whether the application having the highest application manipulation frequency ranking includes video content among the first to third applications.

In operation S952-1, in response to determining that an application including video content among the first to third applications is not the application having the highest application manipulation frequency, the computing apparatus may dispose the application having the lowest application manipulation frequency in the upper portion of the horizontal split screen and dispose the remaining two applications in the lower portion, respectively.

In some embodiments related to operation S952-1, referring to FIG. 15, when the application manipulation frequency ranking is the third application 143, the second application 142, and the first application 141 in that order, the computing apparatus may dispose, among the first to third applications 141, 142, and 143, the first application 141 including video content in the upper portion of the horizontal split screen, and dispose the second application 142 and the third application 143 in the lower portion of the horizontal split screen, respectively.

Here, the method for determining the positions of the second application 142 and the third application 143 within the lower portion of the horizontal split screen may be the same as the method of determining the region, in which each application is disposed when the split screen arrangement direction is the vertical direction, as shown in FIG. 16, and there are two applications constituting the split screen.

In operation S953-1, the computing apparatus may dispose, among the first to third applications, an application having the highest application manipulation frequency rankings and including video content in the lower portion of the horizontal split screen, and dispose the remaining two applications in the upper portion, respectively.

In some embodiments related to operation S953-1, in response to determining that an application including video content exists among the first to third applications, there are two or more applications including the video content, and the application including video content has the highest application manipulation ranking, the computing apparatus may dispose the application having the highest application manipulation frequency ranking and including video content among the first to third applications in the lower portion of the horizontal split screen, and dispose the remaining two applications in the upper portion, respectively.

In some other embodiments related to operation S953-1, in response to determining that an application including video content exists among the first to third applications, there are less than two applications including video content, and the application including video content has the highest application manipulation frequency ranking, the computing apparatus may dispose the application including video content and having the highest application manipulation frequency ranking among the first to third applications in the lower portion of the horizontal split screen, and dispose the remaining two applications in the upper portion, respectively.

In operation S915-1, in response to determining that there are less than two applications including video content among applications constituting the split screen, the computing apparatus may evaluate the application manipulation frequency ranking of the application including video content.

In some embodiments related to operation S915-1, in response to determining that the application including the video content has the highest application manipulation frequency ranking, the computing apparatus may perform operation S953-1. Operation S953-1 can be clearly understood by referring to the above embodiments.

In operation S954-1, in response to determining an application including video content exists among the applications constituting the split screen, there are two or more applications including the video content, and an application having the highest application manipulation frequency ranking does not exist among the applications including the video content, the computing apparatus may dispose the application having the highest application manipulation frequency ranking in the lower portion of the horizontal split screen, and dispose the remaining two applications in the upper portion, respectively.

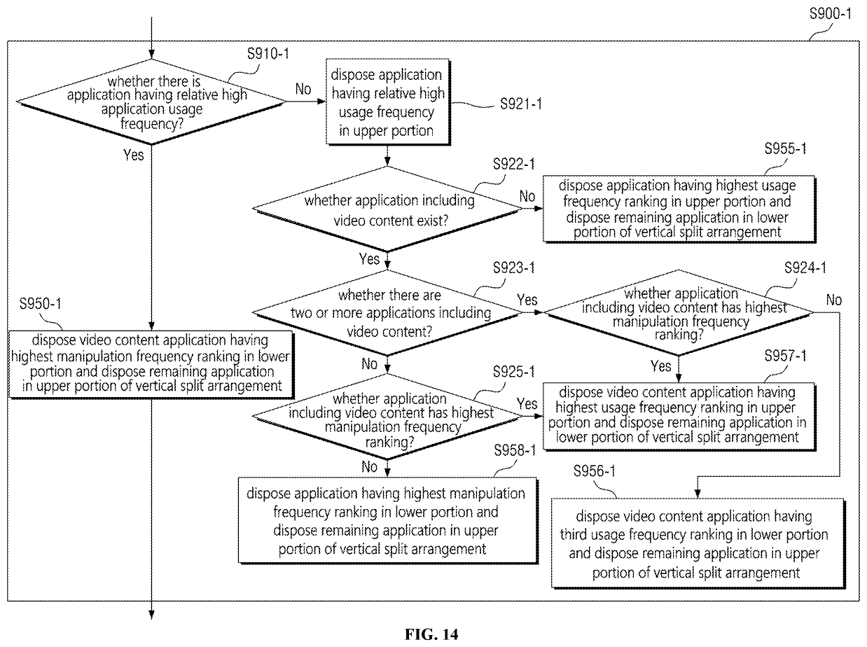

Hereinafter, with reference to FIGS. 14 and 15, operation S920-1 performed by the computing apparatus in response to determining that the application manipulation frequencies of all applications constituting the split screen are similar to each other equal to or greater than the reference value will be described in detail. However, operations and operations to be described below are still included in operation S900-1.

In operation S920-1 shown in FIG. 14, in response to determining that the application manipulation frequencies of all applications constituting the split screen are similar to each other equal to or greater than a reference value, the computing apparatus may evaluate whether, among the applications constituting the split screen, there is an application having the execution number equal to or higher than a reference value compared to other applications constituting the split screen.

In some embodiments related to operation S920-1, the computing apparatus may determine an application usage frequency ranking based on the number of times that applications constituting the split screen have been executed so far.

In operation S950-1, in response to determining that the first rule is the horizontal direction, the number of applications constituting the split screen is three, the manipulation frequencies of all applications constituting the split screen are similar to each other equal to or greater than a reference value, and the execution frequencies of all applications constituting the split screen are similar to each other equal to or greater than a reference value, the computing apparatus may dispose each application on the horizontal split screen based on whether the application is currently activated by the user and the recommended order of the recommended application set.

In some embodiments related to operation S950-1, the computing apparatus may determine that the first application, which is the currently activated application, will be disposed in the lower portion of the horizontal split screen, and the second and third applications dragged from the recommended application set will be disposed in the upper portion in the horizontal split screen, respectively.

In some embodiments related to operation S950-1, the computing apparatus may determine that the first application with a recommendation score of 21 points will be disposed in the lower portion of the horizontal split screen, and the second application and the third application with recommendation scores of 19 points and 17 points, respectively, will be disposed in the upper portion of the horizontal split screen.

In operation S921-1, the computing apparatus may determine that an application having the highest application manipulation frequency ranking among applications constituting the split screen will be disposed in the upper portion of the horizontal split screen. However, the determination of the computing apparatus may be reversed according to the following several operations.

In operation S922-1, the computing apparatus may evaluate whether an application including video content exists among the first to third applications.

In operation S955-1, in response to determining that an application including video content does not exist among the first to third applications in operation S922-1, the computing apparatus may dispose the application having the highest usage frequency in the upper portion of the horizontal split screen, and the remaining two applications in the lower portion, respectively.

In some embodiments related to operation S955-1, referring to FIG. 15, in response to determining that an application including video content does not exist among the first to third applications 141, 142, and 143 in operation S922-1, the computing apparatus may dispose the first application 141 having the highest application usage frequency in the upper portion of the horizontal split screen, and dispose the second and third applications 142 and 143 in the lower portion, respectively.

Here, the method for determining the positions of the second application 142 and the third application 143 within the lower portion of the horizontal split screen may be the same as the method of determining the region, in which each application is disposed when the split screen arrangement direction is the vertical direction, as shown in FIG. 16, and there are two applications constituting the split screen.

In operation S923-1, the computing apparatus may evaluate whether there are two or more applications including video content among the first to third applications in response to determining that an application including video content among exists the first to third applications.

In operation S924-1, in response to determining that there are two or more applications including video content among the first to third applications, the computing apparatus may evaluate whether an application having the highest application usage frequency exists among the applications including video content.

In operation S956-1, in response to determining that an application including video content exists among applications constituting the split screen, there are two or more applications including video content, and an application having the highest application usage frequency does not exist among the applications including video content, the computing apparatus may dispose the application having the lowest usage frequency in the lower portion of the horizontal split screen, and dispose the remaining two applications in the upper portion of the horizontal split screen, respectively.

In operation S925-1, in response to determining that an application including video content exists among the first to third applications, but there are less than two applications including video contents, the computing apparatus may evaluate whether the application including video content has the highest application usage frequency ranking.

In operation S957-1, the computing apparatus may determine that an application including video content and having the highest application usage frequency ranking will be disposed in the upper portion of the horizontal split screen, and the remaining two applications will be disposed in the lower portion, respectively.

In some embodiments related to operation S957-1, referring to FIG. 15, when it is assumed that that the ranking of application usage frequency is the first application 141, the second application 142, and the third application 143 in that order, in response to determining that the first application and the second application 141 and 142 are applications including video content and the first application 141 has the highest application usage frequency ranking, the computing apparatus may dispose the first application 141 in the upper portion of the horizontal split screen, and dispose the second and third applications 142 and 143 in the lower portion of the horizontal split screen, respectively.

Here, the method for determining the positions of the second application 142 and the third application 143 within the lower portion of the horizontal split screen may be the same as the method of determining the region, in which each application is disposed when the split screen arrangement direction is the vertical direction, as shown in FIG. 16, and the there are two applications constituting the split screen.

In some other embodiments related to operation S957-1, referring to FIG. 15, when it is assumed that the ranking of application usage frequency is the first application 141, the second application 142, and the third application 143 in that order, in response to determining that the first application 141 is an application including video content and the first application 141 has the highest application usage frequency ranking, the computing apparatus may dispose the first application 141 in the upper portion of the horizontal split screen and dispose the second and third applications 142 and 143 in the lower portion of the horizontal split screen, respectively.

However, here, the method for determining the positions of the second application 142 and the third application 143 within the lower portion of the horizontal split screen may be the same as the method of determining the region, in which each application is disposed when the split screen arrangement direction is the vertical direction, as shown in FIG. 16, and there are two applications constituting the split screen.

So far, in some embodiments of the disclosure, a method of determining a region, in which each application is disposed when a split screen arrangement direction is a horizontal direction and there are three applications constituting the split screen has been described in detail. Hereinafter, with reference to FIGS. 16 to 18, in operation S900-2 shown in FIG. 12, the method for determining the arrangement position of the application constituting the split screen by the computing apparatus when the first rule for determining the display direction of the split screen is the vertical direction will be described in detail.

FIG. 16 is a flowchart of a method of determining a region, in which each application is disposed when the split screen arrangement direction is the vertical direction and there are two applications constituting the split screen according to some embodiments of the disclosure.

In operation S910-2 shown in FIG. 16, the computing apparatus may evaluate whether there are two applications constituting the split screen.

In some embodiments related to operation S910-2, the computing apparatus may perform operation S900-3 in response to determining that the number of applications constituting the split screen exceeds two, but this will be described later.

In operation S920-2, the computing apparatus may determine the user's main interaction direction in response to determining that there are two applications constituting the split screen. Here, the main interaction direction may mean the direction of the user's hand manipulating the computing apparatus. For example, the meaning that the user's main interaction direction is right may be understood as meaning that the user mainly manipulates the computing apparatus with his or her right hand.

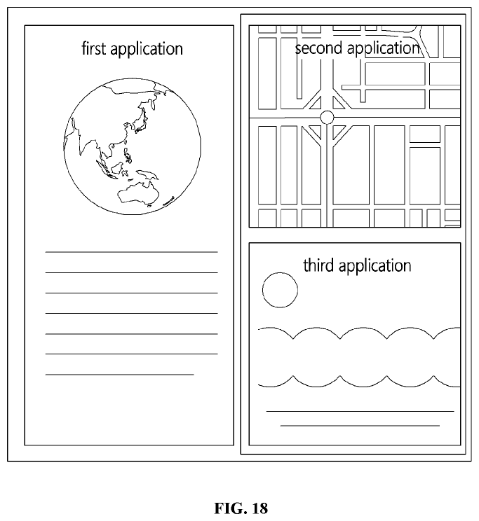

In some embodiments related to operation S920-2, the computing apparatus may determine a main interaction direction of the user based on position information of a region touched by the user. For example, referring to FIG. 18, when it is assumed that the region occupied by the first application 171 is the left region and the region occupied by the second and third applications 172 and 173 is the right region, the computing apparatus may determine that the user's main interaction direction is right if the region with the greater number of touches is the right region.

In some embodiments related to operation S920-2, the computing apparatus may determine a main interaction direction of the user based on a touch trajectory when the user performs a scroll manipulation.

In operation S930-2, in response to determining that the user's main interaction direction is right, the computing apparatus may evaluate whether, among the applications constituting the split screen, there exists an application having an application manipulation frequency equal to or higher than a reference value compared to the other applications constituting the split screens.

In operation S961-2, in response to determining that the user's main interaction direction is right, and the manipulation frequency of the first application is higher than the manipulation frequency of the second application, the computing apparatus may determine that the first application will be disposed on the right side of the vertical split screen.

In operation S940-2, in response to determining that the user's main interaction direction is left, the computing apparatus may evaluate whether, among the applications constituting the split screen, there exists an application having manipulation frequency equal to or higher than a reference value compared to other applications constituting the split screen.

In operation S962-2, in response to determining that the user's main interaction direction is left, and the manipulation frequency of the first application is higher than the manipulation frequency of the second application, the computing apparatus may determine that the first application will be disposed on the left side of the vertical split screen.

In operation S950-2, in response to determining that the user's main interaction direction is right, and the manipulation frequency of the first application and the manipulation frequency of the second application are similar to each other equal to or greater than a reference value, the computing apparatus may evaluate the application usage frequency of the first application and the second application.

In some embodiments related to operation S950-2, in response to determining that the application usage frequency of the first application is higher than that of the second application by a reference value or more, the computing apparatus may determine that the first application will be disposed in the main interaction direction of the user on the vertical split screen.

In operation S963-2, in response to determining that the first rule is vertical direction, there are two applications constituting the split screen, manipulation frequencies of all applications constituting the split screen are similar to each other equal to or greater than a reference value, and the execution frequencies of all applications constituting the split screen are similar to each other equal to or greater than a reference value, the computing apparatus may dispose each application on the vertical split screen based on whether the application is currently activated by the user and the recommendation order of the recommended application set.

In some embodiments related to operation S963-2, the computing apparatus may determine that the first application, which is the currently activated application, will be disposed in the user's main interaction direction of the vertical split screen, and the second application dragged from the recommended application set will be disposed in the remaining region.

In some embodiments related to operation S963-2, the computing apparatus may determine the first application with a recommendation score of 21 points will be disposed in the user's main interaction direction of the vertical split screen and the second application with a recommendation score of 19 points will be disposed in the remaining region of the vertical split screen.

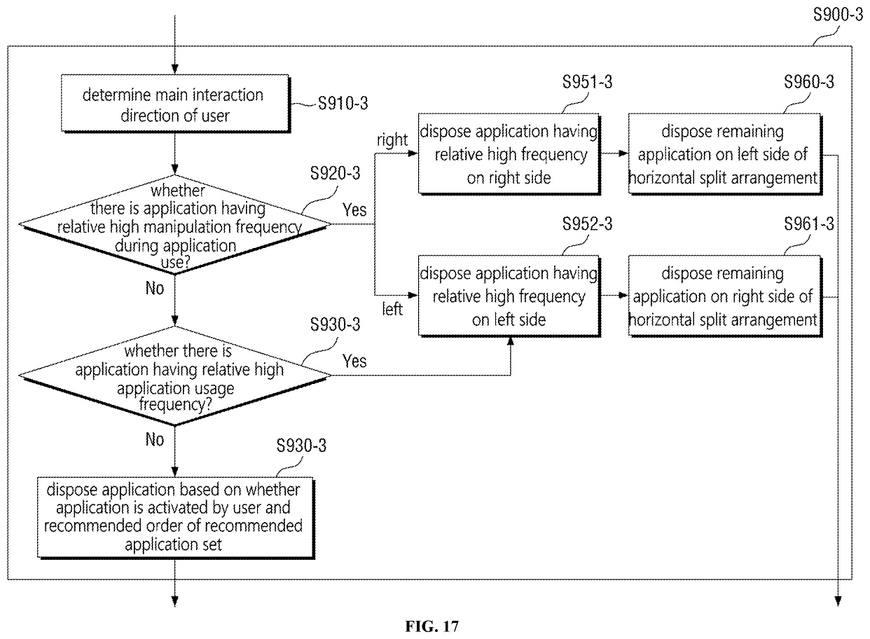

Hereinafter, with reference to FIGS. 17 and 18, a method of the computing apparatus determining a region, in which each application is disposed when the split screen arrangement direction is a vertical direction and there are three applications constituting the split screen will be described in detail.

In operation S910-3 shown in FIG. 17, the computing apparatus may determine the main interaction direction of the user. The method of determining the user's main interaction direction can be clearly understood by referring to the above-described embodiments of operation S920-2.

In operation S920-3, the computing apparatus may evaluate whether, among the applications constituting the split screen, there exists an application having an application manipulation frequency is equal to or higher than a reference value compared to other applications constituting the split screen.

In operation S930-3, in response to determining that manipulation frequencies of the applications constituting the split screen are similar to each other equal to or greater than a reference value, the computing apparatus may evaluate the usage frequency of the applications constituting the split screen.

In operation S950-3, in response to determining that the first rule is vertical direction, the number of applications constituting the split screen is three, the manipulation frequencies of all applications constituting the split screen are similar to each other equal to or greater than a reference value, and the execution frequencies of all applications constituting the split screen are similar to each other equal to or greater than a reference value, the computing apparatus may dispose each application on the vertical split screen based on whether the application is currently activated by the user and the recommended order of the recommended application set.

In some embodiments related to operation S950-3, the computing apparatus may determine that the first application, which is the currently activated application, will be disposed in the main interaction direction of the user of the vertical split screen, and the second and third applications dragged from the recommended application set will be disposed in the remaining region.

In some embodiments related to operation S950-3, the computing apparatus may determine that the first application with a recommendation score of 21 points will be disposed in the main interaction direction of the user of the vertical split screen, and the second and third applications with recommendation scores of 19 points and 17 points will be disposed in the remaining region of the vertical split screen, respectively.

In operation S951-3, in response to determining that the user's main interaction direction is right, and the manipulation frequency of the first application is higher than those of the second and third applications by a reference value or more, the computing apparatus may determine that the first application will be disposed on the right side of the vertical split screen.

In operation S960-3, in response to determining that the first application will be disposed on the right side of the vertical split screen, the computing apparatus may dispose the second and third applications on the left side of the vertical split screen, respectively. Here, the method for determining the positions of the second application and the third application within the left side of the vertical split screen may be the same as the method for determining the region, in which each application is disposed when the split screen arrangement direction is the horizontal direction, as shown in FIG. 12, and there are two applications constituting the split screen.

In operation S952-3, referring to FIG. 18, in response to determining that the user's main interaction direction is left and the manipulation frequency of the first application 171 is higher than those of the second and third applications 172 and 173 by a reference value or more, the computing apparatus may determine that the first application 171 will be disposed on the left side of the vertical split screen.

In operation S961-3, referring to FIG. 18, in response to determining that the first application 171 will be disposed on the left side of the vertical split screen, the computing apparatus may dispose the second and third applications 172, 173 on the right side of the vertical split screen, respectively. Here, the method for determining the positions of the second application and the third application 172, 173 in the right side of the vertical split screen may be the same as the method of determining the region, in which each application is disposed when the split screen arrangement direction is the horizontal direction, as shown in FIG. 12, and there are two applications constituting the split screen.

Hereinafter, the description continues with reference to FIG. 10.

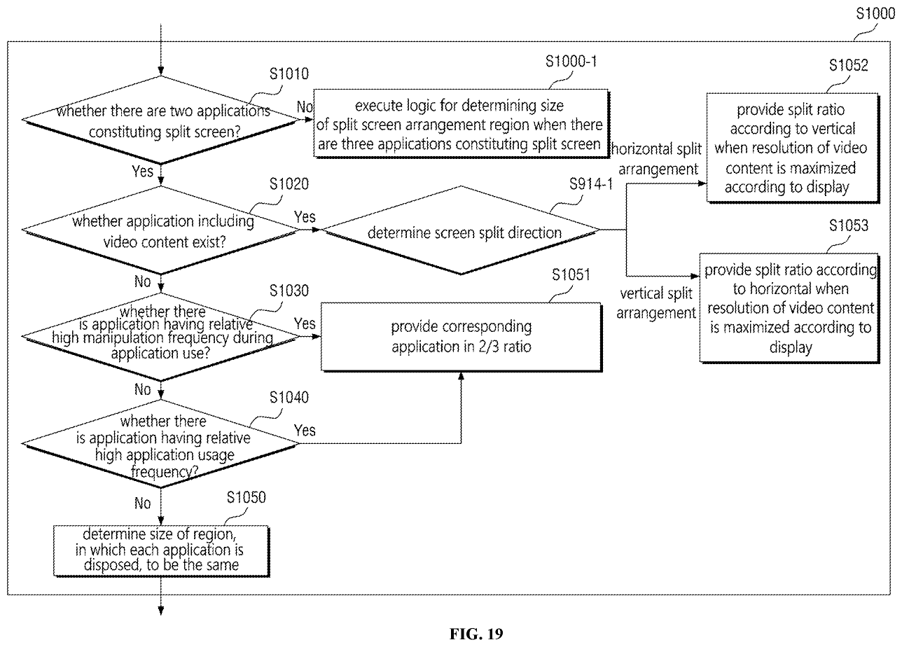

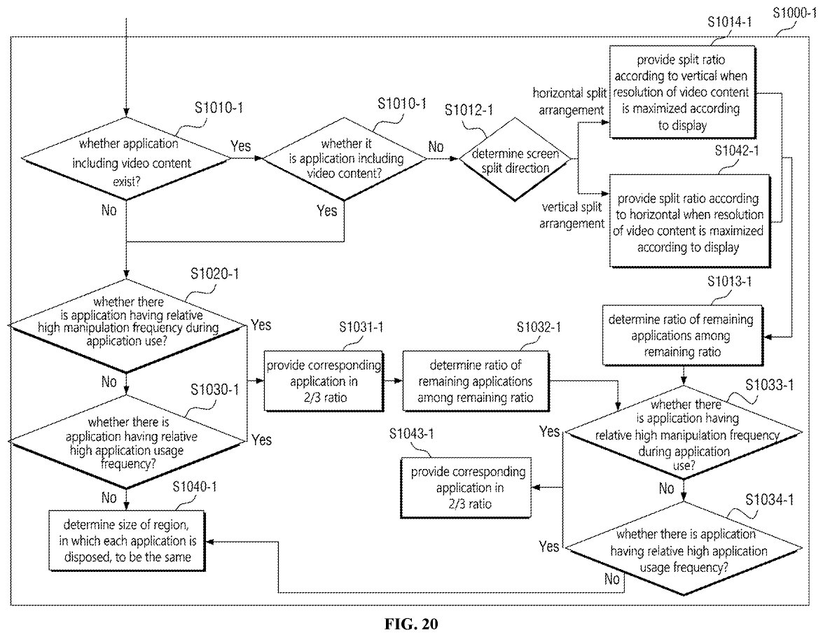

In operation S1000, the computing apparatus may determine a third rule for determining the size of a region where an interface of each of applications constituting the split screen is disposed. In order to describe the operation of determining the third rule in more detail, it will be described with reference to FIGS. 19 to 20.

In operation S1010 shown in FIG. 19, the computing apparatus may evaluate the number of applications constituting the split screen. In some embodiments related to operation S1010, the computing apparatus may perform operation S1000-1 in response to determining that there are three applications constituting the split screen, but this will be described later.

In operation S1020, in response to determining that there are two applications constituting the split screen, the computing apparatus may evaluate whether an application including video content exists among the applications constituting the split screen.

In operation S1021, the computing apparatus may identify the first rule in response to determining that an application including the video content exists.

In operation S1052, in response to the fact that the first rule is the horizontal direction, the computing apparatus may determine a region of the split screen occupied by the application including video content based on the vertical resolution when the resolution of the video content of the application including the video content is maximized according to the display.

In operation S1053, in response to the fact that the first rule is the vertical direction, the computing apparatus may determine a region of the split screen occupied by the application including video content based on the horizontal resolution when the resolution of the video content of the application including the video content is maximized according to the display.

In operation S1030, in response to determining that an application including video content does not exist among the applications constituting the split screen, the computing apparatus may evaluate whether an application having a relatively high manipulation frequency exists among the applications constituting the split screen.

In operation S1040, in response to determining that manipulation frequencies of all applications constituting the split screen are similar to each other equal to or greater than a reference value, the computing apparatus may evaluate the usage frequency of each application constituting the split screen.

In operation S1051, the computing apparatus may determine that, among applications constituting the split screen, the first application having a relatively high manipulation frequency will occupy ⅔ or more of the split screen area. And, the second application will be displayed in the remaining area.

In some embodiments related to operation S1051, the computing apparatus may determine that, among applications constituting the split screen, the first application having a relatively high usage frequency will occupy ⅔ or more of the split screen area. And, the second application will be displayed in the remaining area.

In operation S1050, in response to determining that both the manipulation frequency and the usage frequency of the applications constituting the split screen are similar to each other equal to or greater than a reference value, the computing apparatus may determine that the applications constituting the split screen will have the same area occupying the split screen.

Hereinafter, with reference to FIG. 20, a method of determining a region occupied by each of the plurality of applications when there are three applications constituting the split screen will be described.

In operation S1010-1, the computing apparatus may evaluate whether an application including video content exists among applications constituting the split screen.

In operation S1011-1, the computing apparatus may identify an application including video content among the first to third applications.

In operation S1012-1, the computing apparatus may identify the first rule of the split screen.

In operation S1041-1, in response to the fact that the first rule is the horizontal direction, the computing apparatus may determine a region of the split screen occupied by the application including video content based on the vertical resolution when the resolution of the video content of the application including the video content is maximized according to the display.

In operation S1042-1, in response to the fact that the first rule is the vertical direction, the computing apparatus may determine a region of the split screen occupied by the application including video content based on the horizontal resolution when the resolution of the video content of the application including the video content is maximized according to the display.

In operation S1013-1, the computing apparatus may determine a region, in which the second application and the third application will occupy the split screen other than the region of the first application as shown in FIG. 19.

In operation S1020-1, in response to determining that an application including video content does not exist among the applications constituting the split screen, the computing apparatus may evaluate that an application having a relatively high manipulation frequency exists among applications constituting the split screen.

In operation S1030-1, in response to determining that the manipulation frequencies of all applications constituting the split screen are similar to each other equal to or greater than a reference value, the computing apparatus may evaluate the usage frequency of each application constituting the split screen.

In operation S1031-1, the computing apparatus may determine that a first application having a relatively high usage frequency among applications constituting the split screen will occupy ⅔ or more of the split screen area. And, in operation S1032-1, the second and third applications will be displayed in the remaining area.

In some embodiments related to operation S1031-1, the computing apparatus may determine that a first application having a relatively high manipulation frequency among applications constituting the split screen will occupy ⅔ or more of the split screen area. And, in operation S1032-1, the second and third applications will be displayed in the remaining area.

In operation S1033-1 after operation S1013-1, the computing apparatus may evaluate whether an application with a relatively high manipulation frequency exists among the second and third applications.

In operation S1033-1 after operation S1032-1, the computing apparatus may evaluate whether an application having a relatively high manipulation frequency exists among the second and third applications.

In operation S1034-1, in response to determining that the manipulation frequencies of the second and third applications are similar to each other equal to or greater than a reference value, the computing apparatus may evaluate the usage frequency of each of the second and third applications.

In operation S1043-1, the computing apparatus may determine that the second application having a relatively high usage frequency will occupy ⅔ or more of the remaining split screen area other than the first application area. And, the third application will be displayed in the remaining area.

In operation S1043-1, the computing apparatus may determine that the second application having a relatively high manipulation frequency will occupy ⅔ or more of the remaining split screen area other than the first application area. And, the third application will be displayed in the remaining area.

In operation S1040-1, in response to determining that both the manipulation frequency and the usage frequency of the applications constituting the split screen are similar to each other equal to or greater than a reference value, the computing apparatus may determine that the applications constituting the split screen will have the same area occupying the split screen.

So far, a method for configuring a split screen of a mobile computing apparatus according to another embodiment of the disclosure has been described in detail. The embodiments described above are illustrative in all respects and not restrictive.

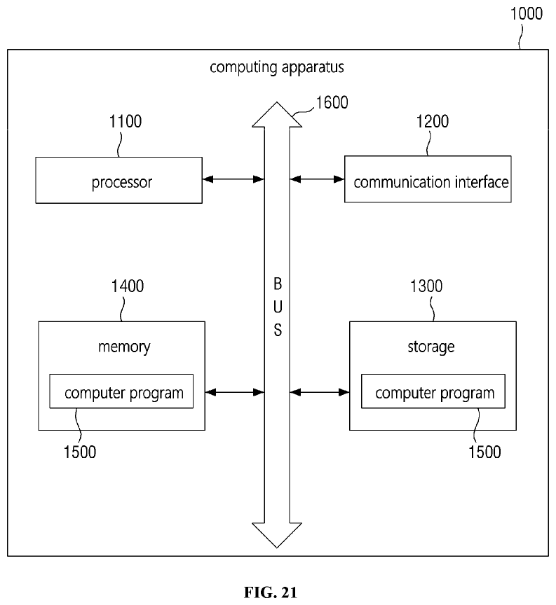

FIG. 21 is a hardware configuration diagram of a computing apparatus 1000 according to some embodiments of the disclosure. The computing apparatus 1000 includes one or more processors 1100, a system bus 1600, a communication interface 1200, a memory 1400 for loading a computer program 1500 executed by the processor 1100, and a storage 1300 for storing the computer program 1500.

The processor 1100 controls the overall operation of each component of the computing apparatus 1000. The processor 1100 may perform an operation for at least one application or program for executing a method/operation according to various embodiments of the disclosure. The memory 1400 stores various data, commands and/or information. The memory 1400 may load one or more computer programs 1500 from storage 1300 to execute methods/operations according to various embodiments of the disclosure.

In some embodiments, the computing apparatus 1000 may be configured using one or more physical servers included in a server farm based on a cloud technology such as a virtual machine.

The technical features of the disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, separation of various configurations is necessarily required, and the described program components and systems may generally be integrated together into a single software product or be packaged into multiple software products.

In concluding the detailed description, those skilled in the art will appreciate that many variations and modifications can be made to the example embodiments without substantially departing from the principles of the disclosure. Therefore, the disclosed example embodiments of the disclosure are used in a generic and descriptive sense only and not for purposes of limitation.

What is claimed is:

1. A method performed by at least one processor, the method comprising:
displaying a currently running application list in response to a first user input;
generating a recommended application set comprising one or more recommended applications for configuring a split screen for a first application included in the currently running application list;
displaying the recommended application set for the first application at a position adjacent to the first application;
selecting, based on a second user input, a recommended application in the recommended application set for the first application;
configuring a split screen comprising the first application and the selected recommended application; and
automatically displaying the split screen.

2. The method of claim 1, wherein the automatically displaying of the split screen comprises automatically displaying the split screen without additional user input after the second user input.

3. The method of claim 1, wherein an application included in the recommended application set is determined based on at least one of:
history information of configuring a split screen with the first application,
history information of a user alternately using the first application and other applications in the currently running application list,
time information, at which a user executed the first application and the other applications in the currently running application list, or
developer information of each of the first application and the other applications.

4. The method of claim 1, wherein the second user input comprises:
a manipulation of dragging an application execution button in the recommended application set and releasing the application execution button in a first region of a screen; and
a manipulation of dragging a reduced interface of a second application included in the currently running application list and releasing the reduced interface of the second application within m pixels of a boundary of a reduced interface of the first application.

5. The method of claim 4, wherein the generating of the recommended application set comprises,
assigning a recommendation score to each of applications in the recommended application set; and
determining that a predefined number of applications among the applications in the recommended application set is to be included in the recommended application set,
wherein the recommendation score is calculated by assigning different weights to:
history information of configuring a split screen with the first application,
history information of a user alternately using the first application and other applications,
time information, at which a user executed the first application and the other applications, and
developer information of the first application and the other applications.

6. The method of claim 5, wherein the generating of the recommended application set further comprises:
based on a determination that a plurality of applications having a same recommendation score exist, generating the recommended application set comprising an application having a larger execution number in the recommended application set.

7. A method performed by at least one processor, the method comprising:
identifying a plurality of applications constituting a split screen, wherein the plurality of applications comprise a first application and a second application;
automatically determining a layout of the split screen by using a property of the first application and a property of the second application; and
displaying the split screen having the automatically determined layout.

8. The method of claim 7, wherein the automatically determining of the layout of the split screen comprises:
determining a first rule for determining a display direction of the split screen based on a type of content provided by each of the first application and the second application;
determining a second rule for determining a region, in which an interface of each of the first application and the second application is disposed, based on the determined first rule, wherein the second rule is determined based on a number of applications constituting the split screen, a user manipulation frequency during execution of each of the first application and the second application and a type of content provided by each of the first application and the second application; and
determining a third rule for determining a size of a region, in which the interface of each of the first application and the second application is disposed, based on the number of applications constituting the split screen, the user manipulation frequency during execution of each of the first application and the second application, and the type of content provided by each of the first application and the second application.

9. The method of claim 8, wherein the determining of the first rule comprises:
based on a determination that at least one of the first application or the second application provides video content, determining the first rule.

10. The method of claim 9, wherein the determining of the first rule further comprises:
based on a determination that an average running time of video content-providing applications is equal to or less than a predefined time, determining that the first rule is a second direction regardless of whether the first application and the second application provide the video content.

11. The method of claim 9, wherein the determining of the first rule further comprises:
based on a determination that at least one of the first application or the second application is a pre-designated application, determining that the first rule is a second direction regardless of whether the at least one of the first application or the second application provides the video content.

12. The method of claim 8, wherein the determining of the second rule comprises: based on a determination that the first rule is a first direction, determining that an interface of the first application having a higher user manipulation frequency than the second application during an execution of the first application and the second application is disposed in a lower portion of an interface of the second application.

13. The method of claim 12, wherein the determining of the second rule further comprises: based on a determination that user manipulation frequencies are similar to each other and equal to or greater than a reference value during an execution of each of the first application and the second application, determining the second rule based on an execution frequency of each of the first application and the second application.

14. The method of claim 8, wherein the determining of the second rule further comprises, based on a determination that the first rule is a second direction:
determining a main interaction direction of a user based on position information of a region on a screen touched by the user; and
determining that an interface of the first application having a higher user manipulation frequency than the second application during an execution of the first application and the second application is disposed in the main interaction direction of the user.

15. The method of claim 8, wherein the determining of the third rule comprises:
determining that an interface of the first application having a higher user manipulation frequency than the second application during an execution of the first application and the second application is to be displayed on two-thirds (⅔) or more of a screen; and
based on a determination that user manipulation frequencies of the first application and the second application are similar to each other and equal to or greater than a first reference value during an execution of each of the first application and the second application, determining that an interface of the first application having a higher execution frequency than the second application among the first application and the second application is to be displayed on two-thirds (⅔) or more of the screen.

16. The method of claim 15, wherein the determining of the third rule further comprises: based on a determination that execution frequencies of each of the first application and the second application are similar to each other and equal to or greater than a second reference value, determining a size of a region where each of the first application and the second application is disposed to be same.

17. The method of claim 8, wherein the determining of the third rule comprises:
based on a determination that the first application providing video content exists among the first application and the second application and that the first rule is a first direction, determining a size of a region where the second application is disposed within the split screen based on a horizontal resolution of the video content of the first application; and
based on a determination that the first application providing video content exists among the first application and the second application and that the first rule is a second direction, determining the size of the region where the second application is disposed within the split screen based on a vertical resolution of the video content of the first application.

18. The method of claim 8, further comprising: based on a determination that:
there is a first history of the first application and the second application configuring a split screen together in the past, and
there is a second history of a user adjusting at least one of the first rule, the second rule, or the third rule to configure the split screen by using the first application and the second application,
configuring a split screen by applying the at least one of the first rule, the second rule, or the third rule adjusted by the user in the past.

19. A computing apparatus comprising:
one or more processors; and
a memory configured to store one or more instructions,
wherein the one or more processors, by executing the stored one or more instructions, perform:
displaying a currently running application list in response to a first user input;
generating a recommended application set comprising one or more recommended applications for configuring a split screen for a first application included in the currently running application list;
displaying the recommended application set of the first application at a position adjacent to the first application;
based on a second user input, selecting a recommended application in the recommended application set for the first application;
configuring a split screen comprising the first application and the selected recommended application; and
automatically displaying the split screen.

20. A computing apparatus comprising:
one or more processors; and
a memory configured to store one or more instructions,
wherein the one or more processors, by executing the stored one or more instructions, perform:
identifying a plurality of applications constituting a split screen, wherein the plurality of applications comprise a first application and a second application;
automatically determining a layout of the split screen by using a property of the first application and a property of the second application; and
displaying the automatically determined split screen having the determined layout.
